(19) United States
(12) Patent Application Publication
(10) Pub. No.: US 2006/0196428 A1
(43) Pub. Date: Sep. 7, 2006

(54) Method for improving chick hatchability

(76) Inventors: Rafael S. Correa, Salisbury, MD (US); Mark Anthony Dekich, Salisbury, MD (US); Erich Frederik Bevensee, Eden, MD (US)

Correspondence Address: JACOBSON HOLMAN PLLC, 400 SEVENTH STREET N.W., SUITE 600, WASHINGTON, DC, 20004, US

(21) Appl. No.: 11/069,969

(22) Filed: Mar. 3, 2005

(51) Int. Cl. A01K 45/00

(52) U.S. Cl. 119/6.8

(57) ABSTRACT

The present invention provides a method for improving the hatchability of avian eggs which are vaccinated or otherwise injected in-ovo, especially in automated egg injection machines. The method injects the avian eggs during a specific period of time of between about 19 days post-fertilization to about 19 days, 8 hours, post-fertilization, and preferably between about 19 days, 4 hours, and about 19 days, 12 hours, post-fertilization. This specific time frame from in-ovo injection has been found to provide a significant increase in hatchability of eggs when compared with eggs injected at 18 days post-fertilization or after 19 days, 8 hours, post-fertilization.

### BACKGROUND OF THE INVENTION

1. Field of Invention

The present invention relates generally to improvement in the hatchability of avian eggs subjected to embryonic in-ovo injection of vaccines and, in particular, to improved hatchability of avian eggs injected using automated egg injection machines.

2. Description of Prior Art

It has been shown that certain live viral vaccines can be administered in eggs before the birds hatch. This procedure is called “in-ovo vaccination.” The in-ovo vaccinated birds develop an earlier immuno-sensibilization to offer improved resistance to the target disease. The exact mechanism by which embryonic vaccination results in increased resistance to challenge at hatch is not yet clear. The poultry industry in the U.S. and abroad has responded to the benefits of in-ovo vaccination and this procedure is rapidly gaining popularity. Over seven billion birds receive vaccines yearly in the U.S. In 1994, about 30% of the U.S. commercial chicken population was vaccinated against Marek's Disease by the in-ovo procedure. In 1997, the figure rose to over 75% or about 6.0 billion chickens.

Examples of methods of in-ovo treatment include treatment with suitable bacteriophages (U.S. Pat. No. 2,851,006), substances including antibiotics, sulfonamides, vitamins, enzymes, nutrients, and inorganic salts (U.S. Pat. No. 3,120,834), providing one or more holes in the egg shell for facilitating penetration (U.S. Pat. No. 3,256,856), and an automated method and apparatus for injecting embryonated eggs prior to incubation with a variety of substances (U.S. Pat. No. 4,040,388).

More recently, many different types of vaccines have been used in poultry, such as multivalent vaccines (U.S. Pat. Nos. 6,048,535, and 6,406,702), live attenuated Salmonella vaccines (U.S. Pat. No. 6,231,871) as well as gene therapy (U.S. Pat. No. 6,730,663).

Until the present invention, the methodology of vaccination technology has not been studied to optimize the hatchability of avian eggs. To maximize the hatch potential when using in-ovo vaccination, especially with automated egg injection machines, the inventors have found that a precise timing of the injection can provide an improved level of hatchability.

### SUMMARY OF THE INVENTION

The present invention provides for a method of improving the hatchability of avian eggs that are inoculated in-ovo, especially eggs inoculated in an automated in-ovo injection machine.

Until the present invention, the poultry industry has routinely inoculated eggs in-ovo for vaccination and prevention of infectious disease in accordance with the teachings of Sharma et al. U.S. Pat. No. 4,458,630 (“the Sharma patent”). The inoculations have been done randomly in the last quarter of incubation between 17 and 21 days, (chickens hatch at about 21 days). The Sharma patent teaches that the chicken embryo's immune system is not fully developed until at least the 17^{th} day post-fertilization.

It is an object of the present invention to provide for an optimal time range in which to inoculate chicken embryos in-ovo, especially with automated in-ovo injection machines, so as to minimally affect the survivability or hatchability of the inoculated eggs. More specifically, it has been surprisingly found that eggs inoculated after about 19 days, 4 hours of incubation, and before about 19 days, 8 hours, is optimum for best hatchability. If additional time is required due to the number of eggs to be inoculated, the in-ovo inoculation process may start earlier, as early as at 19 days, 0 hours, to provide up to an additional 4 hours of inoculation time. In-ovo inoculation after 19 days, 8 hours, is not desirable in accordance with the present invention since internal pipping generally occurs at about 19 days, 12 hours, post-fertilization. Eggs inoculated after 19 days, 0 hours, and before 19 days, 12 hours, exhibit an improved level of hatchability, especially when inoculated in automated egg injection machines.

These and other objects of the invention, as well as many of the attendant advantages thereof, will become more readily apparent when reference is made to the accompanying drawings and following detailed description of the preferred embodiments.

### BRIEF DESCRIPTION OF THE DRAWINGS

FIG. 1 is a chart showing the change in O₂ consumption and CO₂ production in a chicken embryo over time of incubation.

FIG. 2 graphically depicts a chicken embryo at approximately 19 days showing the partial pressures of O₂ and CO₂ in the various structures in the egg.

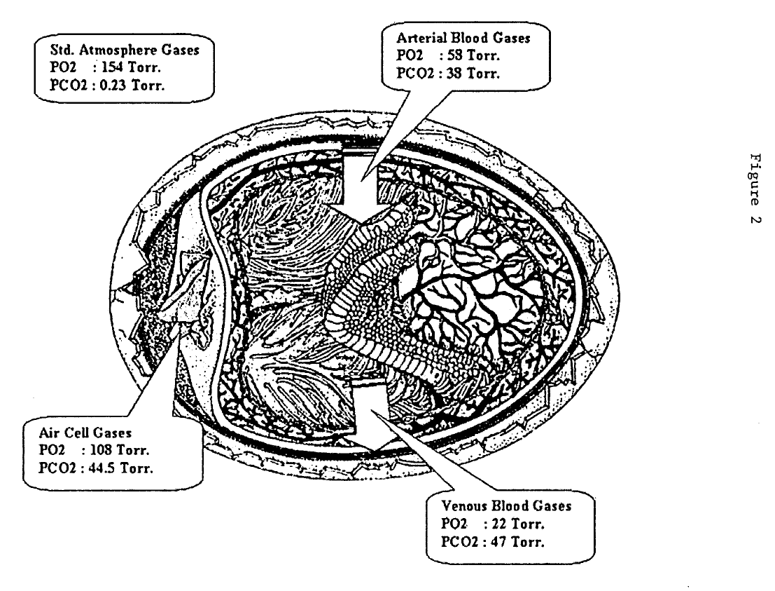

### DETAILED DESCRIPTION AND PREFERRED EMBODIMENTS

In describing embodiments of the invention, specific terminology will be resorted to for the sake of clarity. However, the invention is not intended to be limited to the specific terms so selected, and it is to be understood that each specific term includes all technical equivalents which operate in a similar manner to accomplish a similar purpose.

The typical commercial chicken egg incubators incubate the eggs for 18-19 days, at which time the eggs are transferred to hatchers where the chicks emerge at 21 days. It has been standard practice in the poultry industry to inoculate eggs at the time the eggs are removed from the incubators and before transfer to the hatchers, without regard to the precise length of incubation, so long as it is consistent with the teachings of the Sharma patent.

There are several published studies that describe the changes that take place in the micro-environment of the chicken egg during incubation, especially during the 17^{th} day through the 21st day when hatching occurs. See H. Tazawa et al., Resp. Physiol. (1983) 53:173-185, and A. Visschedijk, Br. Poult. Sci. (1968) 9:197-210. It is believed by the present inventors that the gas exchange of oxygen and carbon dioxide and the oxygen starvation in the air cell of the egg, as well as in the bloodstream of the growing chick embryo, is significant in triggering the hatch process, including the internal pipping, and significant to the external pipping which occurs later in the hatching process.

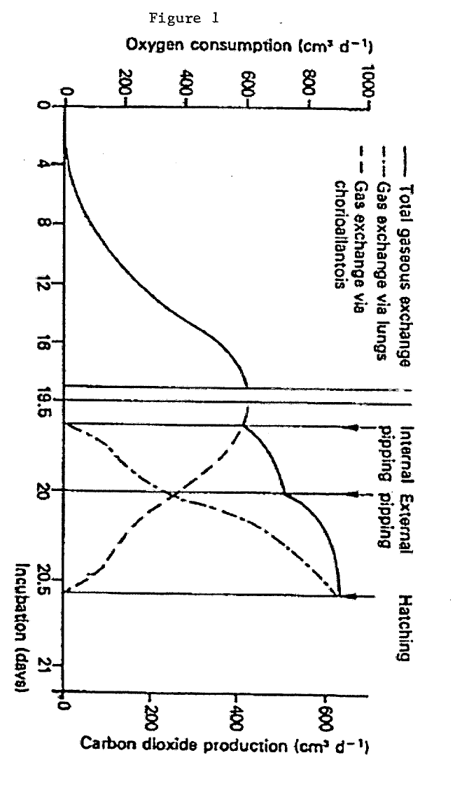

As mentioned earlier, it is known that internal pipping generally occurs at about 19 days, 12 hours post-fertilization. This incubation time correlates to approximately peak O₂ gaseous exchange of the embryo and a large rise in CO₂ production by the embryo. A chart showing O₂ consumption and CO₂ production in a typical egg is shown in FIG. 1. It is further known that approximately at the time when internal pipping begins, the air cell of the egg has elevated levels of CO₂. It is therefore believed by the present inventors, that the elevated CO₂ levels may be the trigger that induces the embryo to begin internal pipping and to begin normal respiratory function of the embryo. This belief is supported by the Tazawa et al. reference, where the authors state that “The acid-base balance [in the egg] is characterized by a marked respiratory acidosis with a slight incipient non-respiratory component on the 19^{th} day of incubation.” Tazawa et al. at 181. Hence, in-ovo vaccine inoculation of avian eggs, especially when using an automated egg injection machine, should proceed between zero and twelve hours before the onset of internal pipping and preferably between zero and about eight hours before the onset of internal pipping.

The present inventors surprisingly found that a significant improvement in hatchability, as much as 1-2% or more, can be achieved for eggs from same-age flocks when the eggs are vaccinated in-ovo at the 19^{th} day of incubation versus at the 18^{th} day of incubation. In view of these results, the present inventors believe that in-ovo injection of the embryos at 18 or 18.5 days post-fertilization interferes with the gas exchange necessary for proper embryonic development and is the cause for the difference in hatchability. More specifically, during in-ovo inoculation, it is thought that the CO₂ levels of the egg environment are altered when the automated egg injector pierces the shell and internal air cell of the egg, and that this change in CO₂ differential pressure can interfere with the development of the embryo, resulting in small but significant 1-3% difference in hatchability.

Studies conducted in connection with this invention found that there is an optimum time period where in-ovo injection of embryos can occur that results in a small but significant increase in hatchability of eggs. By maintaining the CO₂ level in the air cell of the egg until after about 19 days, 4 hours, post-fertilization prior to injection, improved hatchability is achieved. More precisely, the in-ovo injection should occur after about 19 days, 4 hours, and before about 19 days, 12 hours, post-fertilization for maximum improvement of hatchability. In other words, there is an eight hour window prior to the beginning of internal pipping, when in-ovo injection should occur in order to minimally impact hatchability. Hatchability decreases when in-ovo injection occurs later than 19.5 days (or after internal pipping has begun).

The advantage of this increase in hatchability can be significant. For example, if one were to inject approximately 1.2 million eggs per week in an average hatchery, a 1-3% improvement in hatchability would translate into an increase of 12,000-36,000 chicks per week. When multiplied by the number of hatcheries and number of eggs per year, this improvement can result in an increased number of chickens in the millions for the poultry industry.

Hatchability experiments in connection with the present invention were done in four different poultry facilities, using either Jamesway Setter machines (Jamesway Incubator Company Inc., Cambridge, Ontario Canada) or ChickMaster Setter machines (ChickMaster Incubator Company, Medina, Ohio). The studies were done to look at differences in hatchability when injecting embryos in-ovo at 18 days versus 19 days of incubation.

### EXAMPLE 1

In a first series of experiments, eggs from 16 different chicken houses (flocks), or approximately 8,000 eggs from each chicken house, of broilers between 50 to 65 weeks of age, were divided in half. One-half, approximately 4,000 eggs from each of the 16 flocks, was incubated for 18 days, and the other half was incubated for 19 days.

Of the eggs incubated for 18 days, one-half were an experimental group injected in-ovo for Marek's Disease with approximately 100 μl of vaccine on that day and transferred to hatching trays in an Intelliject® automated egg injection machine. The other half of the 18 day incubated eggs were manually transferred from incubators to hatching trays (without in-ovo injection), and the resulting chicks were manually vaccinated one day after hatching according to standard industry practice (Manual Transfer). This Manual Transfer group served as a negative control.

Of the 19 day incubated eggs, one-half were also an experimental group injected in-ovo for Marek's Disease with approximately 100 μl of vaccine on that day and transferred to the hatching trays using an Intelliject® automated egg injection machine. The other half of the 19 day incubated eggs were similarly manually transferred from the incubators to hatching trays (without in-ovo injection), and the resulting chicks were manually vaccinated one day after hatching according to standard industry practice (Manual Transfer). This Manual Transfer group also served as a negative control.

The data from the sixteen flocks was averaged, and the results of these tests are shown in Table 1 below.

TABLE 1

| | (percent of late dead embryos)¹ |
|---|---|
| 18^{th} Day | |
| Experimental Group (In-ovo) | 2.88% |
| Control Group (Manual Transfer) | 2.10% |
| 19th Day | |
| Experimental Group (In-ovo) | 1.25% |
| Control Group (Manual Transfer) | 2.38% |

¹Embryos which died after 17 days of incubation

### EXAMPLE 2

In a second series of experiments, eggs from hens of a single farm living in two side-by-side poultry houses were used to determine if the differences seen in the first experiments were the result of variances in hatchability between flocks. Approximately 16,000 eggs from each poultry house were used in these experiments. One-half of the eggs, approximately 8,000 eggs from each house, were inoculated on the 18^{th} day of incubation, and the other half on the 19^{th} day of incubation, with one-half (about 4,000 eggs) inoculated as the experimental group and the other half (about 4,000 eggs) inoculated as the control group.

The experimental and control group methods used were the same as previously described in Example 1. The results are shown in Table 2 below.

TABLE 2

| | (percent of late dead embryos) | |
|---|---|---|
| | (House 1) | (House 2) |
| 18th Day | | |
| Experimental Group (In-ovo) | 3.40% | 3.50% |
| Control Group (Manual Transfer) | 1.90% | 2.20% |
| 19th Day | | |
| Experimental Group (In-ovo) | 2.20% | 2.70% |
| Control Group (Manual Transfer) | 1.90% | 2.20% |

### EXAMPLE 3

In a third series of experiments, the age of the flock was investigated to determine its possible impact on the hatchability difference. In this experiment eggs from two flocks of hens which were all 65 weeks of age, a total of approximately 16,000 eggs, were used. The eggs were divided into two groups of approximately 8,000 eggs each, an experimental group and a control group. Eggs in the experimental group were in-ovo inoculated at the 19th day of incubation in an Intelliject® automated egg injection machine. Eggs in the control group were transferred to the hatching trays and the chicks manually vaccinated 1 day after hatching following the protocol in Example 1. The results are shown in Table 3 below.

TABLE 3

| 19^{th} Day | (percent of late dead embryos) |
|---|---|
| Experimental Group (In-ovo) | 2.30% |
| Control Group (Manual Transfer) | 3.10% |

The data set forth in Tables 1, 2 and 3 show that late death (death after 17 days of incubation) increased in all of the embryos that were vaccinated in-ovo on day 18 versus embryos that were vaccinated in-ovo on day 19. No lesions or traumas to the embryos were found. Neither was contamination found to be the cause of death. Post-mortem examination showed that some embryos died prior to internal pipping.

### EXAMPLE 4

Two Jamesway setting machines were used during this continuous 12 week trial. In accordance with standard procedure using a Jamesway machine, the eggs from one Jamesway machine were pulled and in-ovo inoculated and transferred to the hatchers in an Intelliject® automated egg injection machine, at 18 days incubation. Operation of the other Jamesway machine was modified so that the eggs were pulled and in-ovo inoculated and transferred to the hatchers in an Intelliject® automated egg injection machine at 19 days incubation. Ninety flocks were used in this study, and approximately 362,800 eggs were incubated through each Jamesway machine, or a total of 725,600 eggs, during the 12 week study. Break out of the egg residue, i.e., those that did not hatch, was performed. Late dead embryos were compared for each of the two groups. The results for each were averaged and are set forth in Table 4 below.

TABLE 4

| | Late Dead | Late Dead | |
|---|---|---|---|
| Date | 18 Days | 19 Days | 19 Day Differential |
| Week 1 | 3.2% | 3.7% | −0.5% |
| Week 2 | 3.1% | 2.3% | 0.8% |
| Week 3 | 2.7% | 1.8% | 0.9% |
| Week 4 | 3.1% | 0.9% | 2.2% |
| Week 5 | 3.2% | 2.0% | 1.2% |
| Week 6 | 3.4% | 1.8% | 1.6% |
| Weeks 7&8 | 2.3% | 1.1% | 1.2% |
| Weeks 9&10 | 3.5% | 1.9% | 1.6% |
| Weeks 11&12 | 4.1% | 2.9% | 1.2% |

It is believed that the results reported above for weeks 1, 2 and 3 are not representative inasmuch as experimentation for modifying the Jamesway setting machine for 19 day incubation was necessary to fully adapt the machine for 19 day incubation instead of the standard 18 day incubation.

Having described the invention, many modifications thereto will become apparent to those skilled in the art to which it pertains without deviation from the spirit of the invention as defined by the scope of the appended claims. The disclosures of U.S. patents, patent applications, and all other references cited above are all hereby incorporated by reference into this specification as if fully set forth in its entirety.

1. A method for increasing the hatchability of avian hatchery eggs wherein said eggs are injected with a beneficial formulation of one or more vaccines, vitamins, nutrients, and trace minerals, said method comprising:
a) removing an avian egg during its incubation period from about 19 days, 0 hours, post-fertilization, to about 19 days, 8 hours, post-fertilization from an incubator;
b) injecting said egg with said formulation; and
c) maintaining said avian egg in a suitable environment until the embryo is viably hatched from said avian egg.

2. The method for increasing the hatchability of avian hatchery eggs of claim 1, wherein said method provides an increase in hatchability of said avian egg of between about 1-3% .

3. The method for increasing the hatchability of avian eggs of claim 1, wherein said method includes removing said avian egg during its incubation period after about 19 days, 4 hours, post-fertilization.

4. The method for increasing the hatchability of avian eggs of claim 1, wherein said injecting said egg was performed in an automated egg injection machine.

5. The method according to claim 1, wherein said formulation includes a vaccine for Marek's Disease.

6. A method for increasing the hatchability of avian eggs wherein said eggs are injected with a beneficial formulation of one or more vaccines, vitamins, nutrients, and trace minerals, said method comprising in-ovo inoculating said eggs shortly before the onset of internal pipping.

7. The method of claim 6, wherein said in-ovo inoculation is performed between 0 and about 12 hours before internal pipping.

8. The method of claim 7, wherein said in-ovo inoculation occurs between 0 and about 8 hours before internal pipping.

9. The method of claim 8, wherein said in-ovo inoculation is performed in an automated egg injection machine.

10. The method according to claim 9 wherein said formulation includes a vaccine for Marek's Disease.

11. A method for increasing the hatchability of avian eggs wherein said eggs are injected with a beneficial formulation of one or more vaccines, vitamins, nutrients, and trace minerals, said method comprising in-ovo inoculating said eggs with said formulation after incubation so as to substantially coincide with peak oxygen gaseous exchange of egg embryos and with a large rise in carbon dioxide production of said egg embryos.

12. The method of claim 11, wherein said in-ovo inoculation is performed between 0 and about 12 hours before internal pipping.

13. The method of claim 12, wherein said in-ovo inoculation occurs between 0 and about 8 hours before internal pipping.

14. The method of claim 13, wherein said in-ovo inoculation is performed in an automated egg injection machine.

15. The method according to claim 14, wherein said formulation includes a vaccine for Marek's Disease.

16. A method for increasing the hatchability of avian eggs wherein said eggs are injected with a beneficial formulation of one or more vaccines, vitamins, nutrient and trace minerals, said method comprising injecting said eggs with said formulation after incubation so as to maintain a carbon dioxide level in an air cell of each egg in an unaltered state until a period of incubation of at least 19 days post-fertilization.

17. The method for increasing the hatchability of avian eggs of claim 16, wherein said period of incubation is at least 19 days, 4 hours, post-fertilization.

18. The method of claim 17, wherein said in-ovo inoculation is performed in an automated egg injection machine.

19. The method according to claim 18, wherein said formulation includes a vaccine for Marek's Disease.
